(19) United States
(12) Patent Application Publication
(10) Pub. No.: US 2005/0196508 A1
(43) Pub. Date: Sep. 8, 2005

(54) Lactose-removed milk product and process for the preparation thereof

(76) Inventor: Joseph Wang, Fairfield, CA (US)

Correspondence Address: JOHN P. COSTELLO, 331 J STREET, SUTIE 200, SACRAMENTO, CA, 95814, US

(21) Appl. No.: 10/877,002

(22) Filed: Jun. 23, 2004

Related U.S. Application Data
(60) Provisional application No. 60/550,773, filed on Mar. 5, 2004.

(51) Int. Cl. A23C 9/12

(52) U.S. Cl. 426/580

(57) ABSTRACT

A sequential filtration process has been developed to reduce the content of carbohydrate, such as lactose, in milk feed stocks such as whole, low fat, skim milk, and milk powder. The milk product produced with the inventive process can be classified as a lactose-removed milk product.

### CROSS-REFERENCE TO RELATED APPLICATIONS

This application claims the benefit of United States-provisional application Ser. No. 60/550,773 filed on Mar. 5, 2004.

### FIELD OF THE INVENTION

This invention relates generally to the field of processes for removing carbohydrate from milk products. More specifically, it pertains to processes directed toward removing lactose from milk products, including whole, low fat, skim milk and milk powder.

### BACKGROUND OF THE INVENTION

Milk is the product of mammary gland secretion. It is a complex and nutritious product that contains more than 100 substances, which can be classified generally into four categories: proteins, fats, lactose and minerals.

Lactose is the principal carbohydrate in milk. Its concentration in milk averages about 4.8% (4.6-5.0%) by weight. While regular milk is one of the most valuable and convenient nutrients to humans, particularly with regard to newborns, there is a great demand in the market for a lactose-removed milk product. This market mainly consists of the following three groups of people:

1. People with lactose malabsorption and lactose intolerance:
Lactose malabsorption and lactose intolerance is caused by a considerably reduced lactase activity in the mucosa of the small intestine.
Lactose malabsorption is the incapacity to quantitatively digest an oral dose of lactose into its constituent simple sugars (glucose and galactose) during its passage through the small intestine. Lactose intolerance results in the symptoms of gastrointestinal discomfort, namely: nausea, gas in the abdomen and intestines, abdominal cramping and distension, belching or flatulence, and /or watery stools after digestion of lactose in milk, or other dairy foods.
About 90% of all human adults in the world show some degree of lactase deficiency, the most deficient of this group retaining only 5-10% of their original lactase activity when compared to infants. The average concentration of enzyme units in infants is 29 per g of protein, in lactose-tolerant adults 17 and in lactase-deficient person approximately 3.
Because of this problem, many people cannot tolerate milk as a daily nutrient source.

2. People with diabetes mellitus:
Diabetes mellitus is a condition caused by the lack of insulin in the body, which results in a too-high blood-sugar level. Prevalence of total diabetes in the United States, of all ages in 2002, was 18.2 million people or 6.3% of the national population. Among them, 13 million people are diagnosed and 5.2 million people are undiagnosed.
It is evident that a milk product with low or no lactose would best meet the nutritional requirements of this group of people.

3. People on the Atkins' diet:
In 1970s, Dr. Robert Atkins, a cardiologist, recommended a diet, which is low in carbohydrates, for people having problems with losing weight. Since then, the “Atkins' diet has become increasingly popular. It is now clear that carb-rich food can inflate the appetite and foster diabetes, and that low-carb diets promote short-term weight loss.
Due to increasing popularity, it is difficult to have an accurate estimation of the Atkins' diet population. It has been estimated that 25.4 million Americans—12 percent of the adult population—have tried the Atkins' diet based upon a study by the Natural Marketing Institute. However, NPD Foodworld, estimates the number of Atkins dieters to be closer to 3 percent of the nation's adult population or about 6 million people, based upon statistical sampling. Nevertheless, based upon these studies, it is believed that the number of Atkins' dieters will continue to increase in the next decade.
Again, it would be advantageous to have a lactose-removed milk product to meet the demand of this group of people.

4. People on regular low-calorie diets:
An estimated 64% of adults in the United States are either overweight or obese, increasing their risk for diabetes, high blood pressure, and heart disease. A calorie is the unit of energy used to measure the amount of potential energy that a food contains. The recommended calorie intake for an adult woman is 1,500 to 1,800 and 2,000 to 2,200 for a man. By decreasing their calorie intake, people on low calorie diets force their bodies to burn stored fat for fuel instead of burning newly obtained calories.
Because a large majority of the population drinks milk, a milk product containing fewer calories would be beneficial to those who are attempting to decrease their calorie intake.

The prior art has attempted to reduce the amount of lactose present in milk products in order to satisfy the three groups of consumers, noted previously. Products presently on the market typically employ enzymatic methods to reduce lactose. Lactaid™ is just such an enzymatically-reduced milk product that is manufactured by McNeil Nutritionals, a division of McNeil-PPC, Inc., of Ft. Washington, Pa. This product claims that it is “100% lactose free,” however it is made by using the lactase enzyme to convert lactose to glucose and galactose. In other words, this product still contains the same quantity of carbohydrates therein, which is undesirable to the dieting population, especially Atkins dieters. Furthermore, the converted carbohydrates give this product a sweet flavor which overpowers the natural milk flavor desired by milk drinkers.

A low-carb product called Carb Countdown™ produced by HP Hood, Inc., of Chelsea, Mass., is classified as a “dairy beverage” and not as a milk product. According to the labeled ingredient list, this product is made by combining together ingredients including water, fat free milk, cream, whey protein concentrate, buttermilk, tricalcium phosphate, disodium phosphate, salt, carrageenan and locust bean gum. Therefore, this product is manufactured by mixing together carb-poor components rather than directly removing carbohydrates from a milk feedstock.

U.S. Patent Application No. 20030031754 (Lang) is directed to a process for making a lactose-free milk and the lactose-free milk product resulting from the process. The process touts a 96% removal of lactose from the final product compared to the initial milk feedstock. The feedstock has a lactose percentage of 4.6-4.9%. The final milk product has a lactose percentage of 0.2%. This lactose removal is accomplished by first subjecting the feedstock to ultrafiltration which reduces the initial 4.6-4.9% down to 3%. Next, the feedstock is subjected to enzymatic treatment which reduces the lactose percentage from 3% down to 0.2% by converting lactose to glucose and galactose. The total carbohydrate still remains at the 3% level. This patent application also discusses attempting to remove the unpleasant sweet flavor of the enzymatic breakdown of lactose by increasing the concentration of proteins in the final milk product. European Patent Specification EP1020430 (Yakabi et al.) discloses removing lactose from milk by using a desalting process.

The publication by Abd El-Salam, M. H. et al. touts a process for the “Recovery of Calcium Phosphate from Milk Ultrafiltration Permeate Concentrated by Reverse Osmosis” (Egyptian J. Dairy Sci. Vo. 31 pp. 183-193). This publication discloses a process for removing calcium phosphate from an ultrafiltration permeate by-product of cheese processing. Ultrafiltration as performed during cheese processing produces a diluted permeate by-product comprised of primarily lactose and minerals. The minerals include milk salts such as calcium phosphate. The permeate must be discarded unless a use can be found for it. One usage for the permeate is to concentrate it further using reverse osmosis (RO) to create a cleaning product. This publication suggests an alternate use for the concentrated RO permeate, namely to apply a process to separate out the calcium phosphate. The process involves separating out the calcium phosphate by raising the pH level of the RO permeate to 9 and precipitating out the calcium phosphate.

Accordingly, a need exists for an effective process for separating lactose from the essential fats, proteins and minerals found in milk. Furthermore, a need exists for a lactose-removed milk product which retains all of the essential proteins, fats and minerals while retaining the flavor of natural milk.

The foregoing reflects the state of the art of which the inventor is aware, and is tendered with a view toward discharging the inventor's acknowledged duty of candor, which may be pertinent to the patentability of the present invention. It is respectfully stipulated, however, that the foregoing discussion does not teach or render obvious, singly or when considered in combination, the inventor's claimed invention.

### SUMMARY OF THE INVENTION

In view of the limitations now present in the prior art, the present invention provides a new and useful process for removing carbohydrate, and particularly lactose, from a milk feed stock. Further, the invention includes the milk product that is produced by the process. The inventive milk product retains all of the proteins, fats, minerals and flavor of milk while removing the lactose component to a level of 95% or greater when compared with the milk feedstock.

One important purpose of the present invention is to provide a new process for removing carbohydrate, and particularly lactose, from a milk feedstock, such as whole, low fat, skim milk and milk powder. This product is desirable for the following four groups of people: (1) people who experience lactose mal-absorption or are lactose intolerant; (2) people who have diabetes mellitus; (3) people who are on the Atkin's diet; and (4) people who are regularly on a diet of low calorie food.

According to the invention, the process is carried out using a sequential membrane filtration process which includes multiple membrane separation steps, namely (1) a microfiltration membrane (MF), or ultrafiltration membrane (UF); (2) a nanofiltration membrane (NF); and (3) a reverse osmosis membrane (RO). Additionally, it is preferred that diafiltration be applied to steps (1) and/or (2), to assure a maximum separation of lactose. It is known that Deionized (DI) water is commonly used for diafiltration to remove solutes in permeate. However, according to the invention, NF permeate is preferably used to remove lactose through diafiltration, because it contains milk micro-nutrients, which includes essential minerals, non-protein nitrogen compounds and some flavor materials. It has been found that milk flavor is greatly improved when NF permeate is used as a diafiltration medium.

Accordingly several advantages and objects of the present invention are:

A principal object of the present invention is to provide a process, which can be used to remove lactose from a milk feed stock such as whole, low fat, skim milk and milk powder.

An object of the present invention is to provide a sequential filtration process, which can be used to produce lactose-removed milk products.

Another object of the present invention is to provide a process, which can be used at low temperature to produce lactose-removed milk products, such that milk proteins, including casein, whey proteins and immunoglobulins, are not denatured.

Another object of the present invention is to provide an alternative milk product—lactose—removed milk—to people who cannot or do not want to drink regular milk products due to the presence of lactose.

Another object of the present invention is to provide a process for efficiently producing a lactose-removed milk product in commercial quantities, using membrane separation methods.

Still another object of the present invention is to provide a lactose-removed milk product which contains most of the essential nutrients found in milk.

Finally, another object of the present invention is to provide a lactose-removed milk product which retains the familiar taste of milk.

### BRIEF DESCRIPTION OF THE DRAWINGS

The invention is described in greater detail below with reference to the accompanying drawings. The drawings are flow charts of the various embodiments of the process which comprise the invention. The flow chart boxes reflect steps in the process and may contain information relating to concentration factors (×) for UF, NF and RO steps or else show figures representing lactose removal in pounds (lbs) and by per cent (%)at each step in the process.

FIG. 1 illustrates a flow diagram of a first embodiment of the inventive process which uses a combination of UF and NF to produce a resulting milk product having a 99% removal of lactose when compared with the starting skim milk feedstock.

FIG. 2 illustrates a flow diagram of a second embodiment of the inventive process which uses a combination of UF and NF to produce a resulting milk product having a 97% removal of lactose when compared with the starting skim milk feedstock.

FIG. 3 illustrates a flow diagram of a third embodiment of the inventive process which uses a combination of UF and NF to produce a resulting milk product having a 95.2% removal of lactose when compared with the starting skim milk feedstock.

FIG. 4 illustrates a flow diagram of a fourth embodiment of the inventive process which uses a combination of UF, NF and RO to produce a resulting milk product having a 95.8% removal of lactose when compared with the starting skim milk feedstock.

### DETAILED DESCRIPTION OF THE INVENTION

The inventive process applies sequential membrane separation processes to create a lactose-removed milk product. The various types of membrane separation processes used in the inventive process include combinations of ultrafiltration, or microfiltration, nanofiltration and/or reverse osmosis. Diafiltration using NF permeate is preferably applied to the UF filtration process to assure the maximum separation of lactose.

These processes are generally defined as follows:

Ultrafiltration (UF) designates a membrane separation process, driven by a pressure gradient, in which the membrane fractionates components of liquid as a function of their solvated size and structure. The membrane configuration is usually cross-flow. In UF, the membrane pore size is larger than nanofiltration (NF) or reverse osmosis (RO), allowing some components to pass through the pores with the solvent.

Microfiltration (MF) designates a membrane separation process similar to UF but with even larger membrane pore size, allowing particles in the range of 0.2 to 2 micrometers to pass through. The pressure gradient is generally lower than that of the UF process.

Nanofiltration (NF) Nanofiltration designates a membrane separation process driven by a pressure gradient where the membrane preferentially separates different fluids or ions. Nanofiltration is a finer filtration process than UF, MF ((or Diafiltration)), but not as fine as reverse osmosis. However NF does not require the same energy to perform the separation as reverse osmosis. Nanofiltration also uses a membrane that is partially permeable to perform the separation, but the membrane's pores are typically much larger than the membrane pores that are used in reverse osmosis.

Reverse Osmosis (RO) designates a membrane separation process, driven by a pressure gradient in which- the membrane separates the solvent (generally water) from other components of a solution. The membrane configuration is usually cross-flow. With reverse osmosis, the membrane pore size is very small allowing only small amounts of very low molecular weight solutes to pass through the membrane.

Diafiltration (DF) is a specialized filtration process in which a retentate is diluted with water or permeate and re-filtered to reduce the concentration of soluble permeate components and increase the concentration of retained components. It can apply to all of the above-mentioned filtration process.

The inventive process described herein employs a combination of the noted membrane separation methods operated in a sequential manner (UF is before NF, which is before RO) to achieve a milk product having a lactose component greater than 95% removed when compared with the lactose component of the starting milk feedstock. The membranes described below, having the given specifications are available from Synder Filtration, Inc., of Vacaville, Calif.

The inventive process requires that UF or MF be combined with NF to create the final milk product. Diafiltration enhances the filtration effectiveness of UF or MF. The MF, UF and diafiltration separation methods are important for removing the larger fat and protein components from the milk feedstock. The UF membrane may have a pore size of between 900 MWCO (Molecular Weight Cut-off) to 30,000 MWCO, but a membrane of approximately 900 MWCO is preferable. The inventor has found that using a 900 MWCO membrane results in superior separation of fat and protein into a retentate while allowing the lactose and mineral components to pass through the membrane, in a permeate, which is then subjected to NF. This UF membrane not only retains a majority of total nitrogen protein, but also non-protein nitrogen materials, which are usually smaller than milk proteins. The UF step, including diafiltration with NF permeate, is preferably carried out at a temperature range of 4-10 degrees Celsius (4-5 degrees Celsius being preferred) to avoid denaturing the milk proteins, including immunoglobumins. The other steps besides UF or MF, such as NF and RO, can be carried out at about 10 degrees Celsius.

NF receives the permeate produced by the UF or MF step and removes the majority of lactose there from. The NF step produces both a retentate comprised primarily of lactose and a permeate which is comprised of minerals and some residual lactose. The NF membrane may have a range of 150-800 MWCO, but it is preferred that the membrane be approximately 150-300 MWCO, since lactose has a molecular weight of 328. RO can be added as a final step and serves to separate the smallest components, such as minerals and residual lactose from the water component. The RO membrane is of a standard size used in the dairy industry and known in the art. The water permeate produced from the. RO step is deionized and can be recycled for use in other steps, such as diafiltration or plant processing water.

The following examples of the inventive process illustrate some of the presently preferred embodiments of the invention. The following examples are just that; exemplary, and not intended to be limiting.

### EXAMPLE 1

TABLE 1
Operation parameters of UF and NF for Example 1.

| | | | Feed Rate | |
|---|---|---|---|---|
| Unit | Inlet P (psi) | Outlet P (psi) | (GPM) | Temp (F.) |
| UF | 60 | 30 | 22 | 50 |
| NF | 240 | 199 | 4 | 50 |

The first example is a no-water added continuous process. It was carried out according to the UF and NF parameters for system inlet pressure, outlet pressure, feed rate and temperature illustrated in Table 1.

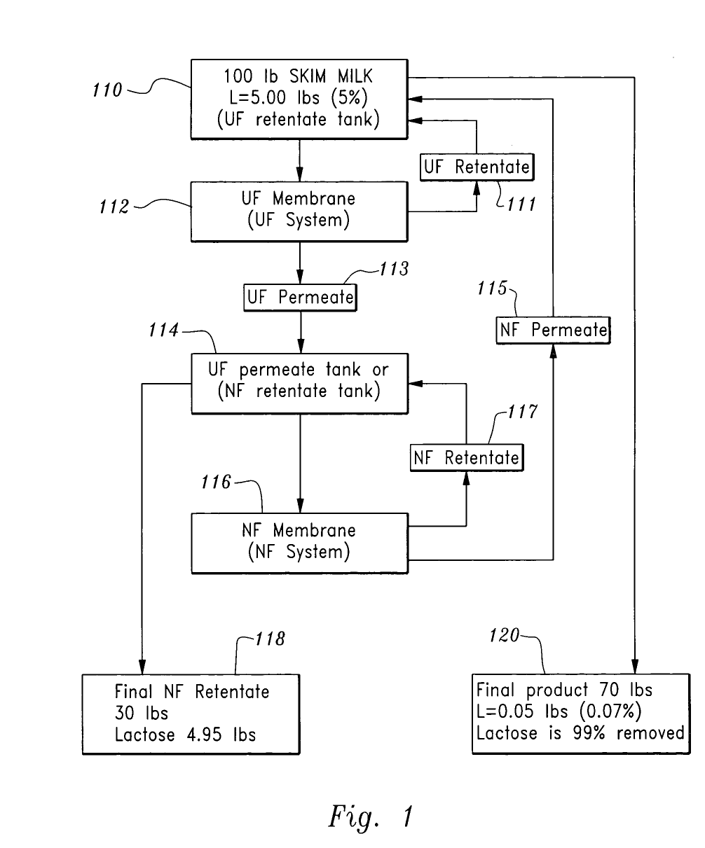

Referring to FIG. 1, a feedstock of 100 lbs of skim milk 110 is subjected to the inventive process. The feedstock has a lactose percentage of 5.0% or 5 lbs by weight. The feedstock is subjected to UF 112, which employs a membrane of 900 MWCO. A UF retentate 111 and a UF permeate 113 is created. The retentate 111 comprises mainly large molecular weight compounds such as fats and proteins like casein and whey, some non-protein nitrogen (NPN) materials, and minerals that are bound to large molecules. The permeate 113 comprises the small molecular weight compounds that pass through the UF membrane, such as lactose, minerals some NPN materials and water. Next, the UF permeate is collected in a tank 114 and is then subjected to NF 116 wherein the NF membrane is between 150-300 MWCO and creates an NF permeate 115 and an NF retentate 117. The NF retentate 117 retains the majority of lactose from the skim milk and the NF permeate comprises minerals, some NPN, water, and residual lactose. During UF, the UF permeate 113 is pumped to the NF system as soon as its volume meets the demand. The NF permeate 115 is then pumped back to the UF retentate tank 110 and serves as a diafiltration media. It has been found that using the NF permeate 115 as a diafiltration media greatly enhances lactose separation. The process is continued until 30 lbs of NF retentate 118 is obtained having approximately 19.8% or 4.95 lbs of lactose. At this point the UF retentate contains approximately 3.33 lbs of milk protein, which is 98% of the original milk protein contained in the skim milk feedstock.

A final milk product 120 is created by continuing the process until the UF retentate 111 reaches 70 lbs in the retentate tank 110 of which the lactose percentage is around 0.07% or 0.05lbs. Of the 70 lb UF retentate final milk product 120, the protein percentage is 4.44. The 0.05 lb amount of lactose remaining in the final milk product represents a 99% 0.05 removal rate when compared to the starting skim milk feedstock amount of 5 lbs.

The serving size of the UF retentate can be altered so that the protein concentration ranges between 0% to 30% higher than that of the starting milk feedstock. The protein concentration of the final milk product is 4.44%, while that of the skim milk feedstock is 3.40%. Therefore, for a standard 240 ml serving size, the final milk product contains 30% more protein in concentration than the starting skim milk feedstock. It has been found that by increasing the protein concentration, the final product has a natural milk flavor without the characteristic sweetness found in milk products which use enzymatic means to remove lactose. Therefore, a lactose-removed product is created which retains the natural taste, without sweetness, of the starting milk feedstock. Also, the calcium percentage in the inventive milk product is 16% higher than that of the starting milk feedstock.

The compositions of skim milk, lactose solution (NF retentate),NF permeate and final 20 UF retentate (lactose removed milk) from Example 1 are listed in Table 1 A below:

(TNP =total nitrogen protein, including true protein and non-protein nitrogen, such as urea and other N-containing small molecules)

TABLE 1A
Comparison of milk compositions with the inventive product of Example 1.

| | | | | | | | | P | Lactose |
|---|---|---|---|---|---|---|---|---|---|
| | | | | Ca | Na | K | Mg | Phosphorous | calorie |
| | TNP % | Lactose % | Fat % | mg/100 g | mg/100 g | mg/100 g | mg/100 g | mg/100 g | in 100 ml |
| Skim | 3.4 | 5.0 | 0.25 | 117 | 49 | 151 | 13 | 90 | 19.2 |
| milk | | | | | | | | | |
| Lactose | 0.29 | 19 | N/A | 76 | 71 | 213 | 14.9 | 50 | 76 |
| solution | | | | | | | | | |
| NF | 0.26 | 0.1 | N/A | 3.2 | 26 | 67 | 0.8 | 30 | 0.4 |
| permeate | | | | | | | | | |
| Lactose | 4.44 | 0.07 | 0.31 | 136 | 45 | 147 | 16 | 110 | 0.24 |
| removed | | | | | | | | | |
| milk | | | | | | | | | |

For a 240 ml standard serving size the final milk product compares favorably with the starting feedstock in terms of protein, and fat, but not lactose, as shown in the Table 1 B directly below.

TABLE 1B
Side by side comparison of skim milk with product of this invention
resulting from the process of Example 1 for a 240 ml serving size.

| | Skim Milk | | Product of this invention | |
|---|---|---|---|---|
| | % | Per serving | % | Per serving |
| Protein | 3.40% | 8.2 gm | 4.44% | 10.7 gm |
| Fat | 0.25% | 0.6 gm | 0.31% | 0.7 gm |
| Lactose | 4.8% | 11.5 gm | 0.07% | 0.1 gm |
| Calories from | | 46 | | 0.4 |
| Lactose | | | | |

### EXAMPLE 2

TABLE 2
Operation parameters of UF and NF for Example 2.

| | | Outlet P | Feed Rate | |
|---|---|---|---|---|
| Unit | Inlet P (psi) | (psi) | (GPM) | Temp (F.) |
| UF | 60 | 52 | 22 | 50 |
| NF | 230 | 197 | 4 | 50 |

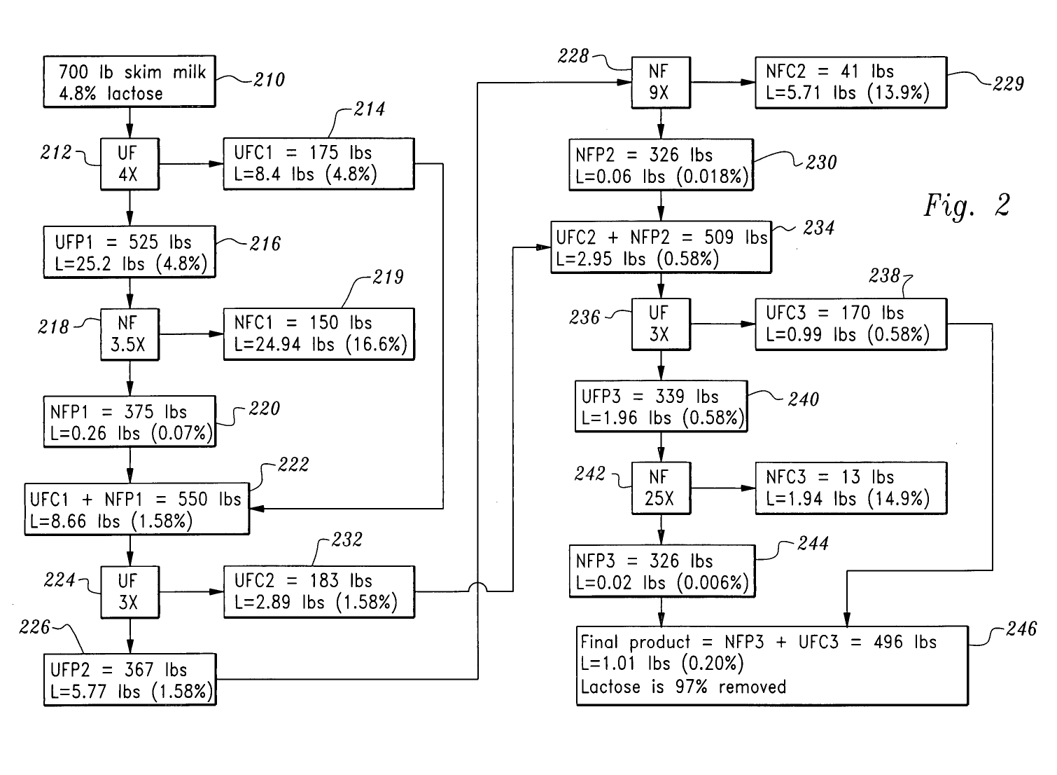

This second example is a no-water added batch process. Referring to FIG. 2, a feedstock of 700 lbs of skim milk 210 is subjected to the inventive process. The feedstock has a lactose percentage of 4.8% or 33.6 lbs by weight. The feedstock is ultrafiltered 212 until a retentate (UFC1) 214 of 175 lbs is reached under a concentration factor of 4×. The 525 lbs of permeate (UFP1) 216 was concentrated 3.5× with NF 218. The permeate (NFP1) 220 of 375 lbs was combined with the UF retentate (UFC1) 214 to form a 550 lb liquid 222, which is then ultrafiltered 3× 224.

The 367 lb permeate (UFP2) 226 was nanofiltered 9× 228 to generate 326 lbs of permeate (NFP2) 230. This permeate was combined with UFC2 232 to form a 509 lb solution 234. This solution was then ultrafiltered 3× 236 to generate 170 lbs of retentate (UFC3) 238 and 339 lbs of permeate (UFP3) 240. The permeate was then nanofiltered 25 fold 242 and 326 lbs of permeate was generated (NFP3) 244. This permeate was combined with UFC3 238 and a final milk product 246 of 496 lbs was obtained. This product contains 1.01 lbs of lactose, for which 97% has been removed by this process when compared with the starting feedstock. This product contains 4.7% protein, which is 38% more protein than the feedstock.

A serving size of 240 ml final milk product (no-water added) contains an amount of protein that is 38% more than the starting skim milk feedstock. A 240 ml serving of final milk product, compares with a 240 ml serving of skim milk feedstock, as follows, in Table 2A.

TABLE 2A
Side by side comparison of skim milk with product of this invention
resulting from the process of Example 2 for a 240 ml serving size.

| | |
|---|---|
| | Product of |
| Skim Milk | this invention |

| | % | Per serving | % | Per serving |
|---|---|---|---|---|
| Protein | 3.4% | 8.2 gm | 4.7% | 11.3 gm |
| Fat | 0.1% | 0.2 gm | 0.1% | 0.2 gm |
| Lactose | 4.8% | 11.5 gm | 0.2% | 0.48 gm |
| Calories from | | 46 | | 1.9 |
| Lactose | | | | |

### EXAMPLE 3

TABLE 3
Operation parameters of UF and NF for Example 3.

| | | Outlet P | Feed Rate | |
|---|---|---|---|---|
| Unit | Inlet P (psi) | (psi) | GPM | Temp (F.) |
| UF | 60 | 50 | 24 | 50 |
| NF | 220 | 199 | 4 | 50 |

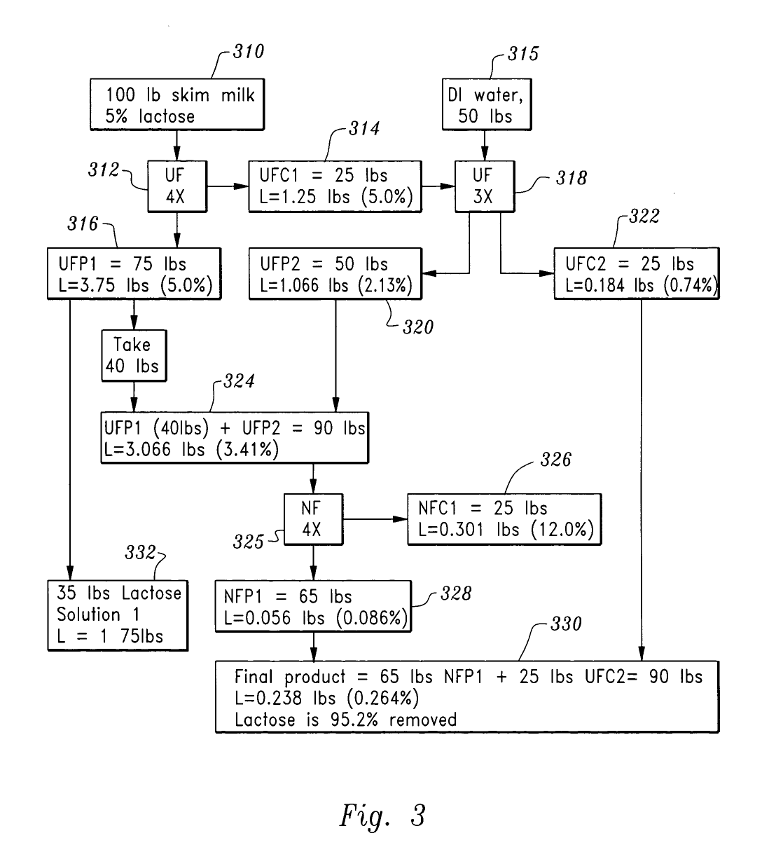

This third example is a water-added UF/NF batch process. Referring now to FIG. 3, a feedstock of 100 lbs of skim milk 310 is subjected to the inventive process. The feedstock has a lactose percentage of 5% or 5lbs by weight. The feedstock is ultrafiltered to 4× concentration 312 until 251 bs of retentate (UFC1) 314 is reached. A 75 lb permeate (UFP1) 316 was obtained. 25 lbs of retentate (UFC1) 314 was dia-filtered by adding 50 lbs of deionized (DI) water 315 at a rate equivalent to the UF permeate (UFP2) 320 rate. After all water is used, the retentate (UFC2) 322 remained at 25 lbs and the permeate (UFP2) 320 was 50 lbs. 40 lbs out of the 751bs of UFP1 were combined 324 with 50 lbs of UFP2 320. This solution was nanofiltered 325 until 25 lbs of retentate (NFC1) 326 was obtained. The permeate (NFP1) 328 so obtained was 67.5 lbs. Next, 65 lbs of NFP1 were combined with 25 lbs of UFC2 330 to form a milk product of 90 lbs. This product contained a total of 0.238 lbs of lactose from which 95.2% had been removed when compared to the feedstock. The final lactose solution contains the balance of UFP1 (35 lbs) 332 and NFC1 326 (22.5 lbs). Both of these combined contain 4.76 lbs or 95.2% of the lactose from the starting feedstock.

The composition of the 901lb product is listed in Table 3A directly below, and is compared with the skim milk feedstock for a 240 ml serving size.

TABLE 3A
Side by side comparison of skim milk with the product of this
invention resulting from the process of Example 3 for a
240 ml serving size.

| | Skim Milk | | Product of this invention | |
|---|---|---|---|---|
| | % | Per serving | % | Per serving |
| Protein | 3.4% | 8 gm | 3.6% | 9.0 gm |
| Fat | 0.1% | 0.2 gm | 0.1% | 0.26 gm |
| Lactose | 5.0% | 12 gm | 0.26% | 0.6 gm |
| Calories from | | 48 | | 2.4 |
| Lactose | | | | |

### EXAMPLE 4

TABLE 4
operation parameters of UF, NF and RO for Example 4.

| | | Outlet P | Feed Rate | |
|---|---|---|---|---|
| Unit | Inlet P (psi) | (psi) | GPM | Temp (F.) |
| UF | 65 | 45 | 26 | 50 |
| NF | 250 | 225 | 4 | 50 |
| RO | 400 | 380 | 5 | 50 |

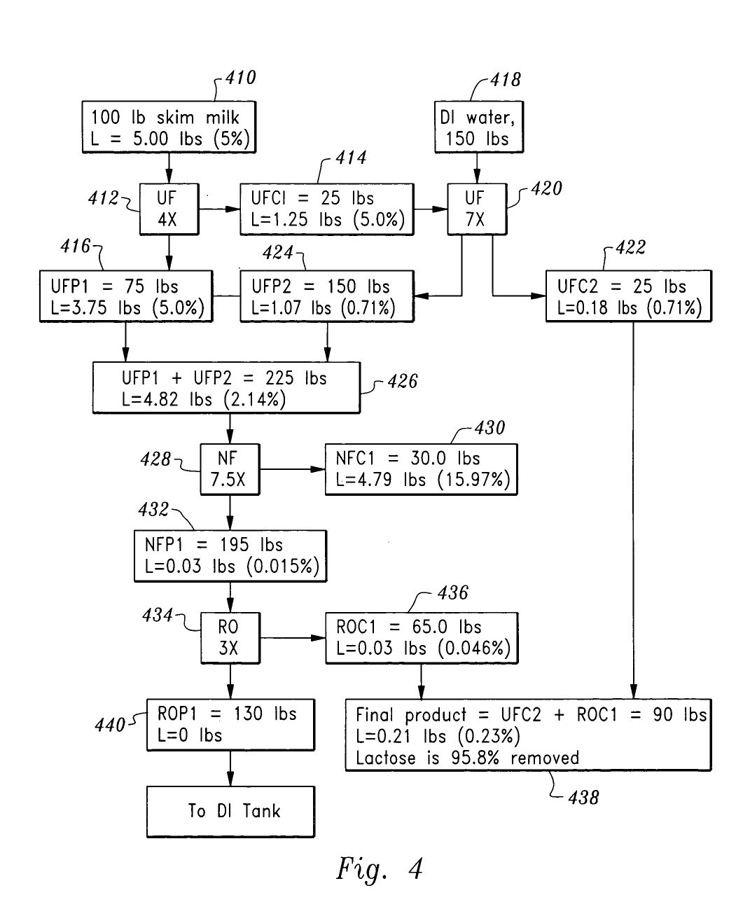

Referring now to FIG. 4, a feedstock of 100 lbs of skim milk 410 was subjected to the inventive process. The feedstock has a lactose percentage of 5% or 5lbs by weight. The feedstock was ultrafiltered 412 to a 4× concentration until a retentate (UFC1) 414 reached 25 lbs and 75lbs of permeate (UFP1) 416 was obtained. 150 lbs of DI-water 418 was-added to UFC1 414 and diafiltered 7× 420 to generate a retentate (UFC2) 422 of 25 lbs and a permeate (UFP2) 424 of 150 lbs. In this diafiltered example, the diafiltration step employs the same 900 MWCO membrane.

UFP1 and UFP2 were combined 426 and then nanofiltered to a rate of 7.5× 428 until 30 lbs of retentate (NFC1) 430 was obtained. The permeate obtained (NFP1) 432 was 195 lbs.

NFP1 432 was concentrated to a level of 3× 434 with an RO membrane until 65 lbs of retentate (ROC1) 436 was generated. The retentate was combined with UFC2 438 to form 90 lbs of milk product. The final milk product has 0.21 lbs of lactose, which represents a 95.8% lactose removal when compared with the feed stock. The 130 lbs of permeate (ROP1) 440 generated from the RO operation can be used to replace part of the DI water for the next batch. The composition of the 90 lb product is listed in Table 4A directly below and is compared with the skim milk feedstock for a 240 ml serving size.

TABLE 4A
Side by side comparison of skim milk with product of this invention
resulting from the process of Example 4 for a 240 ml serving size.

| | Skim Milk | | Product of this invention | |
|---|---|---|---|---|
| | % | Per serving | % | Per serving |
| Protein | 3.4% | 8 gm | 3.5% | 9.0 gm |
| Fat | 0.1% | 0.2 gm | 0.11% | 0.26 gm |
| Lactose | 5.0% | 12 gm | 0.23% | 0.55 gm |
| Calories from | | 48 | | 2.2 |
| Lactose | | | | |

The foregoing written description describes an inventive lactose-removed milk product and a process for achieving the same. Finally, although the description above contains many specificities, these should not be construed as limiting the scope of the invention but as merely providing illustrations of some of the presently preferred embodiments of this invention. This invention may be altered and rearranged in numerous ways by one skilled in the art without departing from the coverage of any patent claims which are supported by this specification.

1. A method for producing a lactose-removed milk product, the method comprising:
ultrafiltering a milk feed stock to produce a retentate and a permeate;
nanofiltering the ultrafiltered permeate to produce a permeate and a retentate; and
adding the ultrafiltered retentate to the nanofiltered permeate to produce a final milk product having at least 95% of the lactose component removed when compared with the milk feed stock.

2. The method as recited in claim 1, wherein the step of ultrafiltration employs an ultrafiltration membrane having a pore size of approximately 900 MWCO.

3. The method as recited in claim 1, wherein the step of ultrafiltration employs an ultrafiltration membrane having a pore size in a range of approximately 900-30,000 MWCO.

4. The method as recited in claim 1, wherein the step of nanofiltration employs a nanofiltration membrane having a pore size in a range of approximately 150-300 MWCO.

5. The method as recited in claim 1, wherein the step of nanofiltration employs a nanofiltration membrane having a pore size in a range of approximately 150-800 MWCO.

6. The method as recited in claim 1, wherein the step of nanofiltration removes an amount of lactose from the ultrafiltered permeate that is at least 95% by weight of the lactose component of the feedstock.

7. The method of claim 1, further comprising the step of subjecting the nanofiltered permeate to reverse osmosis to produce a reverse osmosis retentate and then adding the ultrafiltered retentate to the reverse osmosis retentate to produce a final milk product with a lactose component having at least 95% of the lactose removed when compared with a similar size serving of the milk feedstock.

8. The method of claim 1, wherein the step of ultrafiltration includes a first step of subjecting the feedstock to pure ultrafiltration to create a first permeate and a first retentate and a second step of subjecting the first retentate to diafiltration to produce a second permeate and a second retentate.

9. The method of claim 8, wherein the first and second permeates proceed to the nanofiltration step and the second retentate is added to the nanofiltered permeate to create the final milk product.

10. The method of claim 1, wherein the step of ultrafiltration is carried out within a temperature range of approximately 4-10 degrees Celsius.

11. A lactose-removed milk product produced by the method of claim 1.

12. A lactose-removed milk product produced by the method of claim 1, wherein a serving of the milk product contains between approximately 0.1 to 0.6 gm lactose.

13. The milk product of claim 12, wherein the serving size is 240 ml.

14. A lactose-removed milk product produced by subjecting a milk feed stock to a sequential filtration method, the milk product having a lactose component that is at least 95% removed when compared with the starting lactose component of the feed stock.

15. A lactose-removed milk product produced by subjecting a milk feed stock to a sequential filtration method, wherein a serving of the milk product contains between approximately 0.1 to 0.6 gm lactose.

16. The milk product of claim 15, wherein the serving size is 240 ml.

17. A sequential filtration system, wherein the system operates to remove at least 95% of lactose from a starting milk feedstock to produce a lactose-removed final milk product.

18. A method for producing a lactose-removed milk product the method comprising subjecting a milk feed stock to sequential filtration until a milk product is achieved having a lactose removal of at least 95% when compared to the milk feed stock.

19. A method for achieving enhanced lactose removal from a milk feedstock wherein the method comprises the step of applying diafiltration to an ultrafiltration step using a nanofiltration permeate as a diafiltration media.

20. A method for producing a lactose-removed milk product, the method comprising:
ultrafiltering a milk feed stock through an ultrafiltration membrane of approximately 900 MWCO to produce a lactose-rich permeate and a nutrient-rich retentate;
nanofiltering the lactose-rich permeate to produce a permeate and a retentate; and
adding the ultrafiltered retentate to the nanofiltered permeate to produce a final milk product having a lactose removal of at least 95% when compared to the milk feed stock.
